(19) United States
(12) Patent Application Publication
(10) Pub. No.: US 2002/0136367 A1
(43) Pub. Date: Sep. 26, 2002

(54) Technique for facilitating communications with a party after initial unsuccessful communications therewith

(76) Inventors: Nicholas J. Elsey, West Linn, OR (US); Timothy A. Timmins, Tigard, OR (US)

Correspondence Address: Alex L. Yip, Kaye Scholer LLP, 425 Park Avenue, New York, NY, 10022, US

(21) Appl. No.: 10/062,149

(22) Filed: Jan. 31, 2002

Related U.S. Application Data
(63) Continuation-in-part of application No. 08/816,921, filed on Mar. 13, 1997.
Application No. 08/816,921 is a continuation-in-part of application No. 09/918,867, filed on Jul. 31, 2001.

(51) Int. Cl. H04M 1/64

(52) U.S. Cl. 379/67.1; 379/88.22

(57) ABSTRACT

When a caller calls a called party through an information assistance system, the caller is afforded an option to leave a message for the called party in the event that the call cannot be successfully completed. When the called party receives the message from the information assistance system through a subsequent telephone connection, the called party is afforded an option to call the caller back, without first terminating the connection. In accordance with the invention, the caller may leave the same message for not only the destination number being called, but also other telephone numbers desired by the caller. The inventive message delivery service may also be utilized to perform a wake-up call function, an event reminder function, etc., in accordance with various aspects of the invention.

This application claims under 35 U.S.C. §120 the benefit of U.S. application Ser. No. 08/816,921 filed on Mar. 13, 1997 and U.S. application Ser. No. 09/918,867 filed on Jul. 31, 2001.

### FIELD OF THE INVENTION

The invention relates to a communications system and method, and particularly to a system and method for facilitating communications between a calling party and a called party of a communication call, e.g., telephone call.

### BACKGROUND OF THE INVENTION

It is a common experience to call a telephone operator for information assistance. In a typical information assistance call, a caller identifies to the operator the name and address of a party whose telephone number is desired. In response, the operator locates the desired destination number using, e.g., a computer database. The destination number is then provided to the caller, e.g., by a computerized voice response unit (VRU) which provides automated voicing of the number, and the caller is afforded an option to be connected to the destination number without the need of first terminating the information assistance call.

It is also known in prior art that a voice messaging service may be provided in the event that a caller when calling a called party at a particular contact number encounters a busy signal or a ring-no-answer condition. One such voice messaging service is disclosed, e.g., in U.S. Pat. No. 5,414,754. Specifically, when the caller encounters a busy signal or a ring-no-answer condition in reaching the called party, a prompt offering of the voice messaging service comes on the line. The caller may then press a predetermined key on the telephone keypad to accept the service, whereby the caller can leave a recorded message for the called party. The recorded message is subsequently delivered to the called party at the particular contact number.

### SUMMARY OF THE INVENTION

Although the prior art messaging service provides a convenient way for a caller to convey a message to the same contact number at which the caller cannot successfully reach the called party, it is not particularly efficient when the called party has more than one contact number (e.g., home and work telephone numbers) which he/she could be at when the delivery of the message is attempted. Thus, in accordance with the invention, in response to an unsuccessful communication with a called party, a message for the called party is stored, along with multiple addresses associated with different communication devices to which a version of the message is to be delivered. For example, where the communication device is a telephonic device, the associated address is its telephone number, and the version of the message to be delivered accordingly is a voice version. Where the communication device is a facsimile device, the associated address is its facsimile number, and the version of the message to be delivered accordingly is a facsimile version. A communication connection is subsequently established to deliver the appropriate version of the message to one of the communication devices based on the address associated therewith.

In accordance with an aspect of the invention, the inventive messaging service may also be utilized by a caller to perform a wake-up call function, an event reminder function, etc. In the case of the wake-up call function, the recorded message includes a wake-up message to the caller himself/herself, which is scheduled to be delivered at a preferred wake-up time. In the case of the event reminder function, the recorded message to the caller himself/herself includes, e.g., the time and location of an upcoming event, which is scheduled to be delivered ahead of the event time.

### BRIEF DESCRIPTION OF THE DRAWING

Further objects, features and advantages of the invention will become apparent from the following detailed description taken in conjunction with the accompanying drawing showing an illustrative embodiment of the invention, in which:

FIG. 1 illustrates an information assistance system in accordance with the invention;

FIG. 2 illustrates a switch connected to other components in the system of FIG. 1;

FIG. 3 illustrates a voice response unit (VRU) connected to other components in the system of FIG. 1;

FIG. 4 illustrates a routine for preparation for delivery of a message recorded by a caller to a destination party through the system of FIG. 1;

FIG. 5 illustrates a data format of a data file used for delivery of the recorded message in accordance with the invention;

FIGS. 6A and 6B jointly illustrate a routine for delivering the recorded message to the destination party and providing the destination party with an option to call back the caller in accordance with the invention;

FIG. 7 illustrates an additional step for inclusion in the routine of FIG. 4 in a second embodiment; and

FIG. 8 illustrates an additional step for modifying the routine of FIG. 6B in an alternative embodiment.

### DETAILED DESCRIPTION

The invention is directed to a technique for facilitating communications between a caller and a called party of a communication call, e.g., telephone call. The inventive technique enables a called party to effectively return a telephone call to a caller who earlier left a message for the called party, which message is delivered through an information assistance system.

In a well known manner, a caller can call an information assistance system, e.g., by dialing a predetermined access number, to request, among other information, the telephone number of a desired destination party. In response to such a request, an operator at the system searches a computer database for the requested destination number based on certain data provided by the caller, e.g., the destination party's name/address. (It should be pointed out that the term “operator” here broadly encompasses entities that are capable of providing assistance in a telecommunication environment, including without limitation human operators, voice response/recognition capabilities, web-enabled operator services, and other automated and electronic access.) The caller is then afforded an option to be connected to the destination number without the need of first terminating the information assistance call. Once the caller accepts such an option, a connection to the destination number is established through the information assistance system.

However, the caller may encounter a busy signal, a ring-no-answer condition, or other communication problem on the connection, and thus unsuccessfully reach the destination party. In that case, in an illustrative embodiment the caller is afforded an option to leave a message for the destination party. Once this option is selected, the caller is prompted to record the message and any other information. One or more components including, e.g., a switch host computer and voice response unit (VRU) in the information assistance system described below then establish in a cooperative fashion an outbound connection to the destination number to attempt delivery of the recorded message to the destination party. However, it should be noted that the components used for the establishment of the connection for the message delivery may vary with the actual implementations.

In accordance with the invention, after the destination party receives the message from the information assistance system on the phone, the destination party may choose to be connected to the caller who left the message, without first terminating the message delivery call.

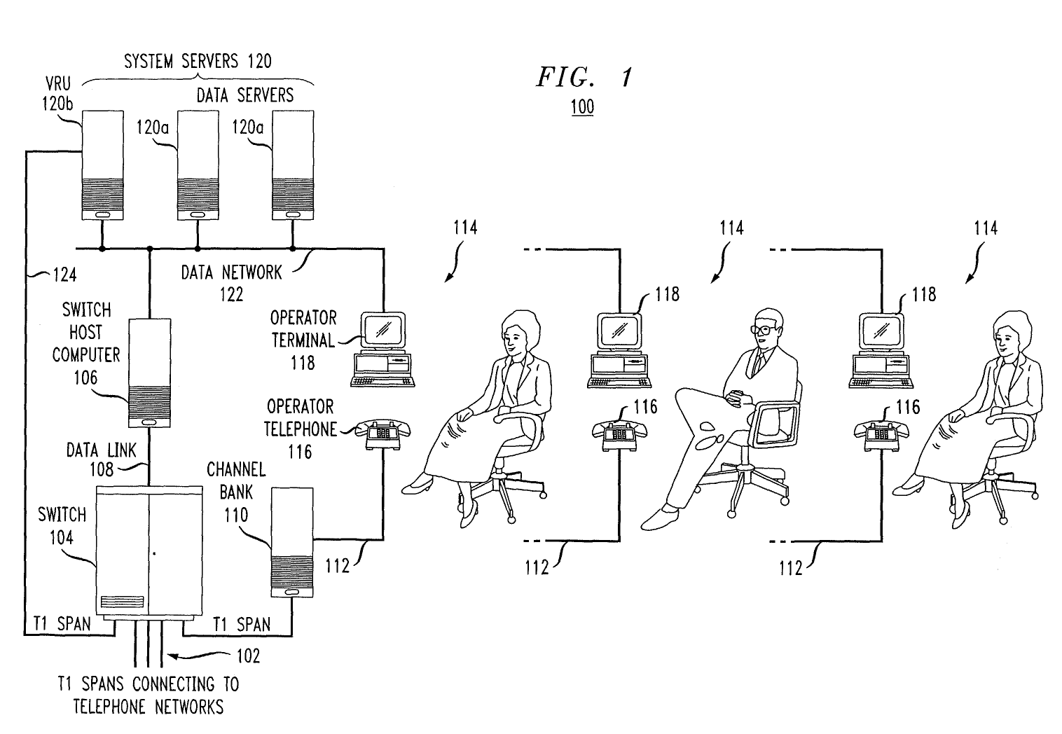

FIG. 1 illustrates information assistance system 100 embodying the principles of the invention. As shown in FIG. 1, one or more external communication links 102 connect information assistance system 100 to telephone networks. Communication links 102 connect to switch 104, which is connected to switch host computer 106 via switch data link 108.

Switch 104 is attached via a T1 communication link to channel bank 110, and from there connects to operator channel 112 and operator telephone 116. Operator telephones are located at each of one or more operator positions, numerically denoted 114. Using operator data terminal 118, a human operator at operator position 114 in this instance accesses one or more system servers 120, which are interconnected via data network 122. Switch host computer 106 is also connected to data network 122. Finally, switch 104 is connected to one or more VRUs. Each connection to a VRU employs a T1 voice server link (a first voice server link 124 is shown in FIG. 1).

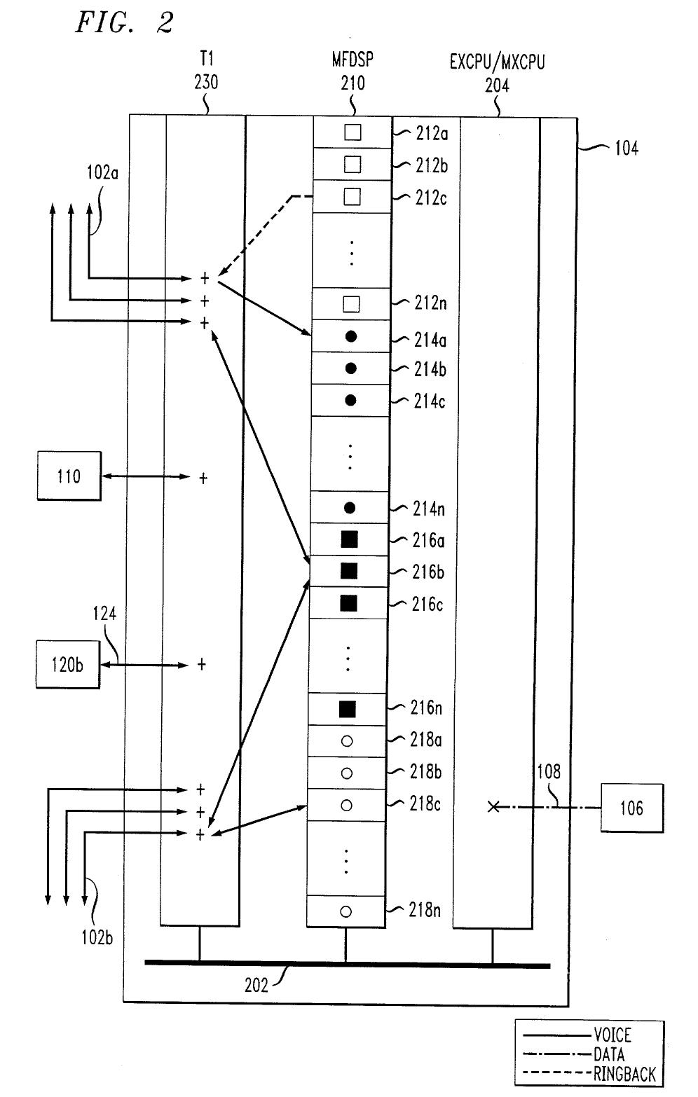

As stated above, communication links 102 provide telephone connections to information assistance system 100 for incoming information assistance calls and also provide access to external telephone networks over which outgoing calls are placed. An incoming call is received via one of inbound channels 102a (shown in FIG. 2), each of which provides two-way communications. On the other hand, an outgoing call is placed over one of outbound channels 102b (shown in FIG. 2), each of which provides two-way communications. There is generally one outbound channel for every inbound channel, so that for every incoming call to information assistance system 100, there is an outbound channel for an outgoing call to the caller's desired party. Communication links 102 may, in an illustrative embodiment, be comprised of one or more T1 communication spans which are known in the art. In such an embodiment, each individual call over a T1 span, whether into or out of switch 104, utilizes one of the 24 individual channels into which a T1 span is segmented, each channel providing two-way communications.

Alternatively, all 24 channels of a T1 span may be utilized for both inbound and outbound calls, with well known telecommunications techniques handling any glare conditions.

Switch 104 will now be described in further detail with reference to FIG. 2. Operation of switch 104 is governed by computer-readable instructions stored and executed on switch host computer 106. In one embodiment of the invention, switch 104 comprises an Excel LNX 2000 switch and switch data line 108 comprises a 38.4 kb serial link; in another embodiment, switch data link 108 comprises an Ethernet link.

Switch 104 includes expandable central processing unit (“EXCPU”) 204 and/or matrix central processing unit (“MXCPU”) 204. EXCPU/MXCPU 204 serves as an interface for switch 104 to switch host computer 106 (via switch data link 108).

EXCPU/MXCPU 204 and other components of switch 104 communicates through shared communication path 202, commonly called a “midplane.” In the present embodiment, midplane 202 utilizes a time division multiplexing (“TDM”) method of sharing a common pathway. Thus, a plurality of data and/or voice streams can be interlaced onto the single path, separated by time.

Another board-level component of switch 104 is multi-frequency digital signal processor (“MFDSP”) unit 210, which includes four single in-line memory module (“SIMM”) packagings. Each SIMM packaging is comprised of four DSP arrays. Each DSP array is composed of multiple, illustratively sixteen, programmable DSPs. The DSPs can be programmed or reprogrammed to function as, among other things, call progress analyzers (“CPA”), call progress generators (“CPG”), multi-frequency (“MF”) receivers or transmitters, dual-tone multi-frequency (“DTMF”) receivers or transmitters, or conference units, depending upon the demand placed on system 100 and switch 104 for each corresponding function.

CPAs, numerically denoted 218, are sensitive to, and capable of identifying, telephone connection status conditions and signals including ring tone, busy, recorder, PBX intercept, SIT intercept, vacant code, reorder-SIT, no circuit LEC, reorder-carrier, no circuit-carrier, dial tone, continuous on tone, and silence. In an exemplary embodiment of the invention, each CPA monitors only one of outbound channels 102b at a time. In other embodiments of the invention, one CPA may be applied to more than one outbound channel. However, to ensure that connection status condition are properly detected, the number of outbound channels monitored by one CPA should be kept to a minimum. In still other embodiments of the invention, two or more DSPs may be applied to a single outbound channel.

CPGs, numerically denoted 212, generate tones to customers connected to system 100, such as the ringback tome customers hear when they are routed to an operator.

DTMF receivers, numerically denoted 214, listen for DTMF tones generated by customers' telephones, such as when a customer presses a telephone key. DTMF receivers are capable of detecting and identifying which key was pressed (i.e., the numbers 0-9 or the characters “*” or “#”) and passing that information to switch host computer 106 for appropriated action. DTMF receivers are assigned to monitor inbound channels for a configurable period of time, illustratively, from the time of a caller's initial connection to switch 104 to the time the caller disconnects, including the duration of all outbound call legs made on the caller's behalf. Once applied to an inbound channel, a DTMF receiver allows switch 104 to detect the press of a telephone key, perhaps done in order to activate tone-triggered return transfer as described in U.S. Pat. No. 5,797,092 issued Aug. 18, 1998 to Cox et al., which is incorporated herein by reference, or another feature of information assistance system 100.

Conference units, numerically denoted 216, enable switch 104 to connect two or more voice paths in a balanced manner, thereby providing the necessary voice connections between calling parties, called parties and information assistance providers.

In the present embodiment, each DSP array provides multiple instances of the function for which it is programmed, the exact number depending upon the specific function. For example, each DSP array programmed to provide CPA, CPG, or DTMF receiver functions provides sixteen instances of the chosen function. In other words, a DSP array programmed to provide call progress analyzer functions contains sixteen separately and independently functional and controllable CPAs. A DSP array programmed to provide conference unit functions, however, provides only four instances of such function. The programmable DSPs on MFDSP unit 210 are managed by switch host computer 106 via EXCPU/MXCPU 204, which keeps track of which DSPs are available and which are allocated.

An additional board-level component of switch 104 is T1 interface unit 230. Switch 104 contains one or more T1 interface units; each unit provides connections to eight T1 (1.544 Mb/sec) spans, each of which is comprised of 192 64 kb voice channels per T1 interface unit. In FIG. 2, T1 interface 230 dedicates twelve channels on each of six of the eight spans to incoming calls and the other twelve to outgoing calls. Alternatively, as mentioned before, all 24 channels on a T1 span may be shared by both incoming and outgoing calls. The seventh T1 span serves as voice server link 124, and the eighth functions as a link to channel bank 110 and operator channel 112. Voice server link 124 and operator channel 112 are used to connect information assistance callers to a voice server or a human operator, respectively.

It should be noted that the arrangement of the T1 spans in FIG. 2 is for illustrative purposes only. The actual number of T1 spans per VRU or operator may vary in different implementations. For example, the T1 spans may be arranged in a group of 16 or more, rather than 8 as in the illustrative embodiment.

It will also be recognized by one skilled in the art that multiple instances of switch 104 may be incorporated into a telephone network or information assistance system 100 without exceeding the scope of the invention.

Switch host computer 106 stores and executes computer-readable instructions for the purpose of, among others, configuring and operating switch 104 and directing the transfer of calls through switch 104. It also directs the playback of recorded greeting and messages to callers connected to system 100. Switch host computer 106 directs the playback of the appropriate message by identifying the inbound channel 102a to which the caller is connected and specifying the message to be played.

Further, switch host computer 106 maintains call data for each information assistance call connected to system 100. The call data stored on the host computer consists of the most recent assistance request from each caller, and includes one or more of: the originating or caller's telephone number derived from a call set-up signal known as an “Automatic Number Identifier (ANI)”, the date and time of the caller's connection to information assistance system 100, the T1 span and channel the caller is connected to, the caller's desired telephone number, the status of the caller's previous information assistance request, which operator assisted the caller, etc. Some of such call data and additional call data are stored on system servers 120, as described below. The call data stored on switch host computer 106 and system servers 120 are provided to information assistance providers when a caller makes multiple information assistance requests in one call to system 100. By considering the collected call data, such as the information that was provided to a caller in a previous request, an information assistance provider can tailor subsequent assistance to be more effective.

Switch host computer 106 also directs the transfer of information between itself and system 120 (via data network 122) as well as between system servers 120 and switch 104 and operator position 114 (via channel bank 110 and operator channel 112).

Operator position 114 includes means by which a human operator receives calls, determines caller's informational needs, searches for and retrieves information from system servers 120, provides information to callers, and initiates outgoing calls. In an illustrative embodiment, an operator at operator position 114 is provided with a telephone headset 116 for interacting with callers, and data terminals 118, connected to data network 122, for interacting with system servers 120.

System servers 120, which are interconnected via data network 122, include one or more data servers 120a which provide and manage data services within system 100. Data servers 120a maintain databases containing telephone and business directories, billing information, and other information in computer-readable form to be searched by operators in response to callers' requests. Data servers 120a also store call data for later retrieval by information assistance providers furnishing subsequent assistance to a caller.

The software used to create and manipulate the databases on data servers 120a is known in the art and allows information assistance providers to search the databases by name, address, type of goods or services, geographic region, etc.

System servers 120 also include one or more VRUs, e.g., VRU 120b in FIG. 1, which provides all or a subset of the operator functions provided by a human operator at operator position 114. For example, VRU 120b stores and delivers messages that human operators would otherwise be required to frequently repeat for callers, such as greetings, closing messages, and the callers' requested telephone numbers. In addition, in accordance with the invention, VRU 120b allows a caller to store a message for a called party whom the caller cannot successfully reach, subsequently establishes a connection from system 100 to deliver the message to the called party, and enables the called party to call back the caller without first terminating the connection.

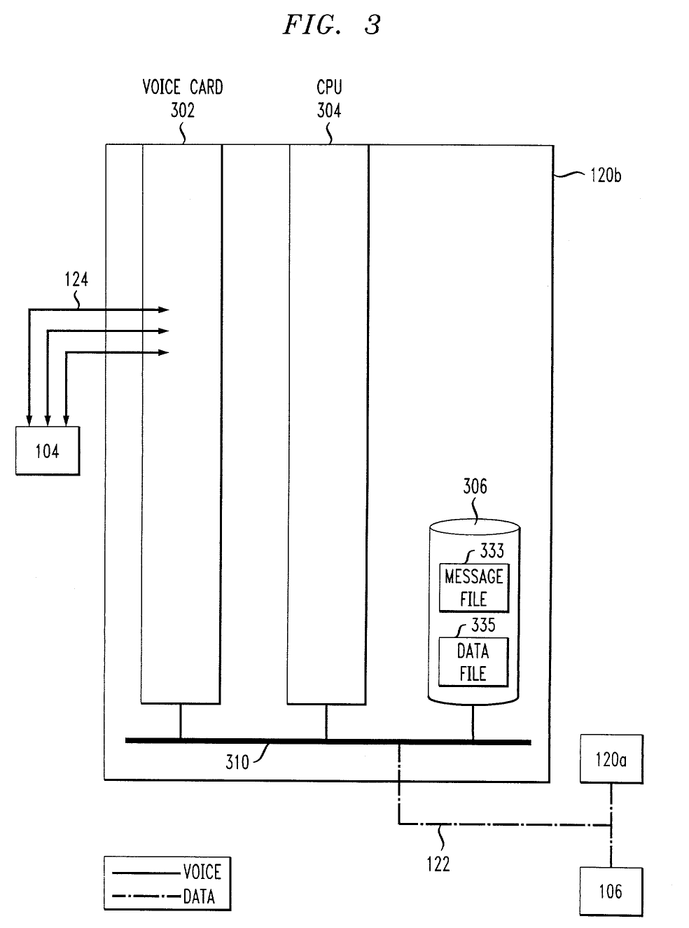

FIG. 3 illustrates VRU 120b, which is connected to switch 104 via voice server link 124, and to switch host computer 106 and data servers 120a via data network 122. VRU 120b includes, inter alia, at least one voice card, e.g., voice card 302, which serves as an interface between voice server link 124 and VRU 120b. Voice card 302 monitors and controls communications over voice server link 124. Its capabilities include DTMF tone detection and generation, voice recording and playback, and call progress analysis. Thus, similar to switch 104, VRU 120b is capable of detecting connection status conditions, detecting customer key presses, and generating tones.

VRU 120b also includes typical computer components such as central processing unit (CPU) 304, data storage unit 306, and bus 310 for transferring voice and data signals. VRU 120b may also contain a voice recognition subsystem (not shown) for receiving verbal input from a party connected to the VRU.

Voice server link 124 provides voice connections between switch 104 and VRU 120b, thereby connecting callers to VRU 120b to receive automated operator assistance. Link 124 in this instance is comprised of one or more T1 spans, with each one of the 24 channels of each span providing two-way communications.

For example, an information assistance call is received by system 100 at T1 interface 230 of switch 104 via one of inbound channels 102a. The information assistance call may originate at virtually any communication device capable of communications with system 100, e.g., a wireless telephone, wireline telephone, personal digital assistant (PDA), mobile communication device, etc. In receiving the call, system 100 also receives call set-up signals containing data concerning the caller's identity, such as the caller's ANI, and the area of the call's origination, such as the originating cell site. This information may be used to verify that the caller is authorized to be connected to the desired destination party via system 100.

Switch host computer 106 collects call data. The call data is updated as information assistance system 100 takes action on behalf of the caller. If no operator is immediately available, the call is placed in an automatic call distribution queue, which is maintained by switch host computer 106. Once connected to an operator, computer 106 directs the playback of a greeting message from VRU 120b for the caller.

The caller typically then states his/her information assistance request by identifying the destination party he/she wishes to contact. The operator searches databases of information (e.g., listings of private individuals and businesses), stored on data servers 120a, for the appropriate destination telephone number. Database records matching the caller's query may be displayed on the inquiring operator's data terminal 118 in a variety of formats, such as alphabetical, random, etc. In this instance, the operator selects the appropriate destination number and initiates an outgoing call for the caller through one of outbound channels 102b. Switch host computer 106 is notified of the outgoing call and automatically instructs switch 104 after outdialing to apply CPA 218 to the outbound channel and DTMF receiver 214 to the inbound channel which the caller is on. Switch 104 then connects the caller on the inbound channel to the outgoing call on the outbound channel. A successful call, in which the destination telephone is answered, is recognized by T1 interface 230 by detecting, on the outbound channel, an answer supervision occasioned by the bit transition that occurs when the destination telephone converts from an on-hook status to an off-hook status.

It should be noted that where SS7 out-of-band signaling is implemented, e.g., the answer supervision coming from an SS7 signaling link, separate from the outbound channel, CPA 218 does not need to be applied to the SS7 voice trunk. Instead, call progress information (busy, ring-no-answer, number unavailable, answer supervision, etc.) can advantageously be determined more effectively from the SS7 signaling protocol than the in-band counterpart through the outbound channel.

However, the call is unsuccessful if CPA 218 detects a busy signal, ring-no-answer condition, or other telephone connection status condition or signal indicative of a communication problem such as reorder, PBX intercept, SIT intercept, vacant code, reorder-SIT, no circuit LEC, reorder-carrier, no circuit-carrier, no dial tone, continuous on tone, or silence. Switch 104 identifies the condition or signal, and notifies switch host computer 106. Subsequent action depends upon which connection status condition or signal was detected.

If the detected condition is identified as a busy signal, ring-no-answer condition or a communication problem, switch 104 drops CPA 218 and DTMF receiver 214 and transfers the call to VRU 120b through voice server link 124. Switch host computer 106 and data servers 120a transmit over data network 122 to VRU 120b the associated call data including, among others, the caller's telephone number (i.e., the ANI) and the destination telephone number. VRU 120b then plays a message to the caller, explaining the detection of the busy signal, ring-no-answer condition or communication problem, and initiates a DTMF detection, which capability is provided by voice card 302, on the inbound channel associated with the caller to detect keys pressed by the caller.

VRU 120b also presents the caller with an audio menu offering several information assistance options. By way of example, the audio menu includes such choices as having VRU 120b to recite the dialed telephone number by pressing the “#” key, to transfer the caller to an operator by pressing the “*” key, to record a message for later delivery to the destination party by pressing the “2” key, and so forth. The caller's selection may, alternatively, be spoken into the caller's communication device and received by a voice recognition subsystem associated with, or contained within, VRU 120b.

Assuming in this instance that the caller presses the “2” key to choose to record a message for later delivery to the destination party, VRU 120b leads the caller through a succession of prompts and responses, making the necessary recordings, including the message to be delivered, and checking the caller's satisfaction with the results. In this illustrative embodiment, the caller is afforded an option to record the caller's name and/or the destination party's name. VRU 120b then elicits from the caller preferences concerning delivery of the recorded message.

It should be pointed out at this juncture that in actual implementations such options and preferences affordable to the user may vary and, indeed, some or all of the options and preferences may be pre-configured, or their selections may be skipped by the user in favor of default settings.

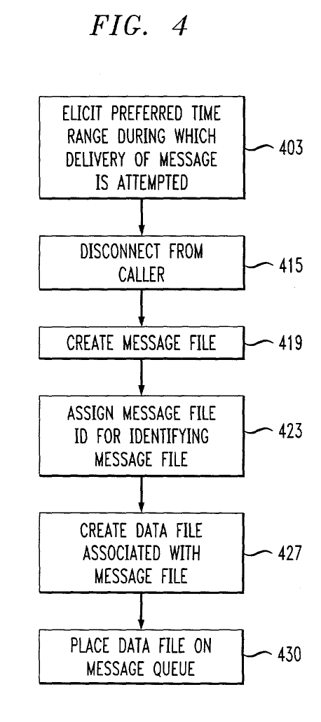

For example, VRU 120b elicits from the caller the preferred time range within which the delivery of the message is attempted, as indicated at step 403 in FIG. 4. In response, the caller may press the appropriate keys to indicate the start and end times of the preferred range. For instance, depression by the caller of “8,” “0,” and “0” keys in that order at a start time prompt, followed by “1,” “7,” “0,” and “0” keys in that order at an end time prompt, indicates that the preferred time range is from 8 a.m. to 5 p.m. VRU 120b is then disconnected from the caller, as indicated at step 415. VRU 120b at step 419 creates a message file (denoted 333) which contains the message, and any caller's name and destination party's name recorded by the caller. Message file 333 is stored in storage 306. VRU 120b at step 423 assigns a message file identification (ID) for identifying message file 333.

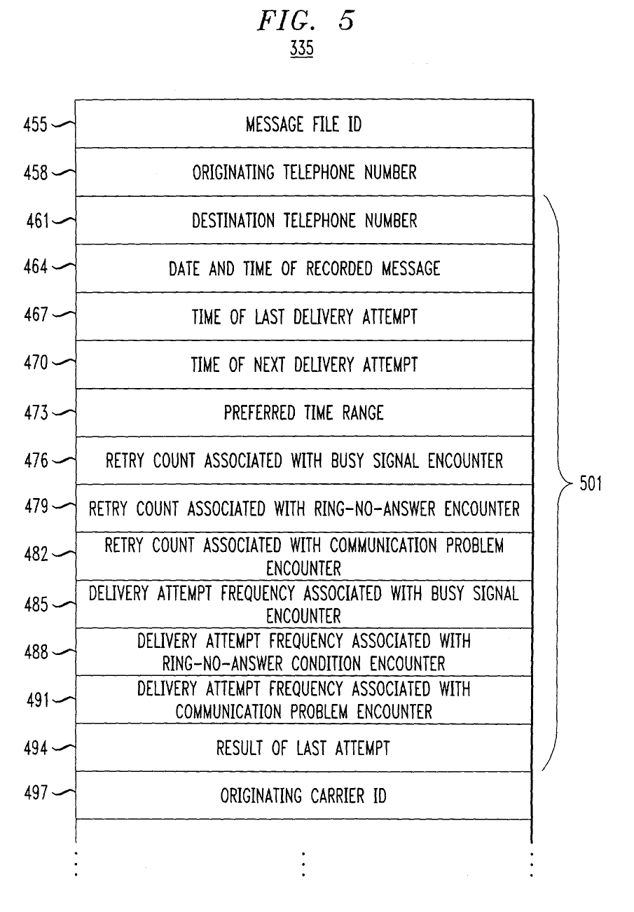

VRU 120b at step 427 creates a data file (denoted 335) associated with message file 333. FIG. 5 illustrates the data fields in file 335, which contains therein the message file ID in field 455. It also contains the originating telephone number in field 458, which may be derived from the ANI; the destination telephone number in field 461; the date and time when the message was recorded in field 464; the time of the last attempt to deliver the message in field 467; the time of the next attempt to deliver the message in field 470; the caller's preferred time range during which the message is delivered in field 473; the retry count associated with a busy signal encounter in field 476; the retry count associated with a ring-no-answer condition encounter in field 479; the retry count associated with a communication problem encounter in field 482; the delivery attempt frequency associated with a busy signal encounter in field 485, the delivery attempt frequency associated with a ring-no-answer condition encounter in field 488; the delivery attempt frequency associated with a communication problem encounter in field 491; the result of the last attempt, e.g., encountering a busy signal, ring-no-answer condition, or communication problem, in field 494; an originating carrier identification (ID) in field 497; etc. The originating carrier ID identifies the carrier providing the telephone service to the caller, which in this instance specifies the values in fields 476, 479, 482, 485, 488 and 491 as part of the service requirements. Alternatively, as further described below, some or all of these field values may be specified by the caller as his/her preferences in a caller profile. In any event, the retry count values 476, 479 and 482 may or may not be identical. They are initially set to a predetermined maximum value. As further described below, each time when a particular condition (e.g., busy, ring-no-answer or communication problem) is encountered in a message delivery attempt, the corresponding retry count value is decremented until it reaches zero. At such time, no further delivery attempt would be made.

Similarly, the delivery attempt frequency values x (i.e., once every x minutes) in fields 485, 488 and 491 may or may not be identical. In fact, the delivery attempt frequency value associated with a busy signal encounter in field 485 is preferably higher than that associated with a ring-no-answer condition encounter in field 488. This stems from the fact that an encounter of a busy signal in a delivery attempt indicates that a person is currently attending to a call at the destination station and only unavailable until the end of the current call. Thus, a relatively high delivery attempt frequency in that situation is warranted to increase the likelihood that the message delivery call would be answered by at least the same person shortly after the current call. On the other hand, an encounter of a ring-no-answer condition in a delivery attempt may indicate that no one is at the destination station answering the call, and may remain status quo for an indeterminate period. The result of the last attempt registered in field 494 determines which corresponding frequency in field 485, 488 or 491 is to be used for timing the next delivery attempt.

It should be noted that the above-described fields in data file 335 are for illustrative purposes only. It will be appreciated that other fields may also be included, such as a field that identifies the specific carrier market from which the caller's call originates. Such carrier market information may be important where system 100 is required to originate the subsequent calls (i.e., message and return calls) on the carrier T1 spans dedicated to the same market.

Data file 335 in this instance is stored in storage 306. In an alternative embodiment, information in data file 335 is stored in a relational database, e.g., of the SQL type, in a central location. In that case, based on the collective data file information in the central location, the status of the nationwide message delivery activity can be more readily obtained, tracked and/or displayed in real time.

As mentioned before, some or all of the caller elicited options described above, e.g., the time range during which the recorded message is to be delivered, may be predefined in a caller profile stored in storage 306. Such a caller profile is identified by the caller's ANI. Thus, the predefined options or preferences in the caller profile are retrievable by VRU 120b based on the caller's ANI. The caller profile may contain preferences not only defined by the caller, but also by the carrier to which the caller subscribes, by the subject information assistance service, and/or by other entities involved. For instance, the message delivery time range may be restricted by the carrier to avoid such abuse by the caller as requiring a message delivery between 3 a.m. and 4 a.m. to a residence. In that case, information assistance system 100 determines the appropriate delivery time range based on the predefined preference by the carrier. Further, based on the caller's origination information and the destination number, system 100 may according to a caller preference time-shift the message delivery time range when it is determined that the caller (e.g., in California) and the called party (e.g., in New York) are located in different time zones (e.g., a three hour difference between New York and California).

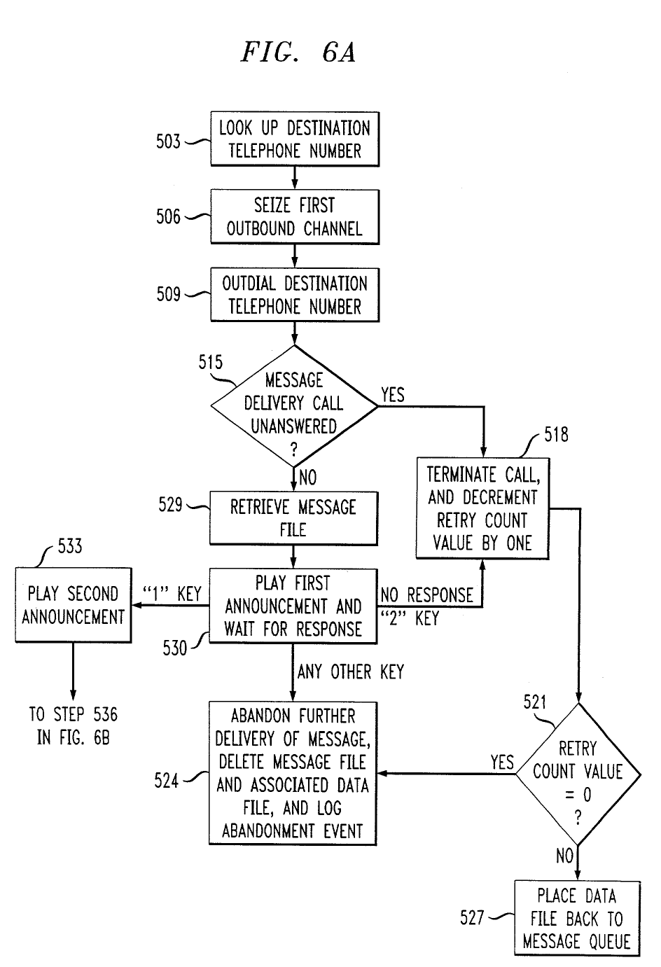

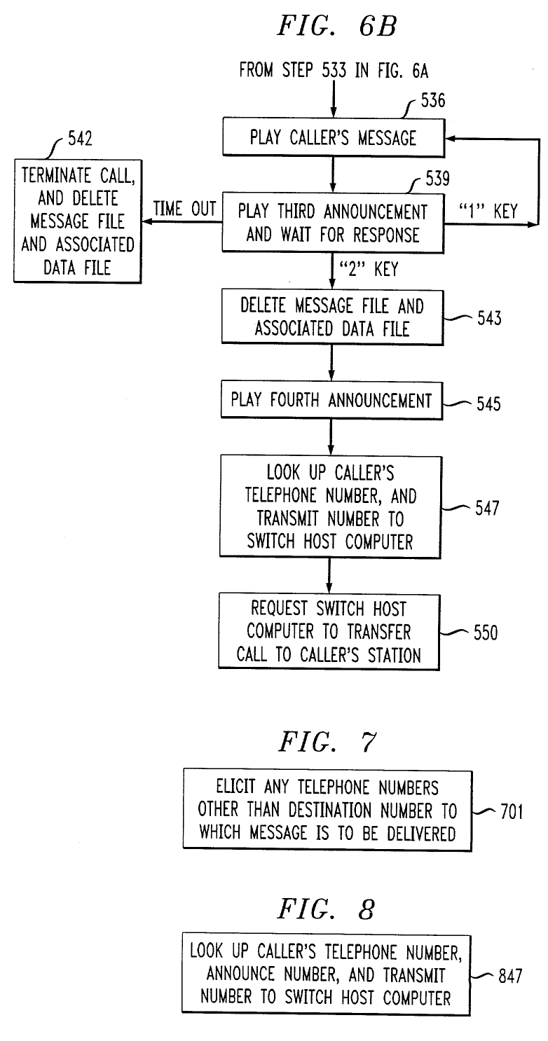

Referring back to FIG. 4, at step 430 VRU 120b places data file 335 on a message queue, which specifies the time for the next message delivery attempt in field 470. Such time is determined based on the time of the last attempt in field 467, the selected delivery attempt frequency, and the preferred time range in field 473. When data file 335 reaches the front of the message queue and when the specified delivery time arrives, VRU 120b is triggered to attempt delivery of the message. As illustrated in FIG. 6A, VRU 120b at step 503 looks up the destination telephone number in field 461 of data file 335. VRU 120b initiates an outgoing call by seizing a first one of outbound channels 102b from T1 interface 230, as indicated at step 506. VRU 120b then transmits the destination telephone number, through switch host computer 106, to switch 104 to outdial the destination telephone number, as indicated at step 509.

Switch host computer 106 then causes application of a CPA 218 in switch 104 to the first outbound channel to determine the status of the message delivery call. The call status is reported back to VRU 120b. VRU 120b at step 515 determines whether the message delivery call is unanswered as a busy signal, ring-no-answer condition or other communication problem (e.g., PBX intercept, SIT intercept, vacant code, reorder-SIT, no circuit LEC, reorder-carrier, no circuit-carrier, no dial tone, continuous on tone, and silence) on the first outbound channel is detected by CPA 218. In that case, VRU 120b terminates the call and decrements the retry count value associated with the detected condition (i.e., the corresponding retry count value in field 476, 479 or 482) by one, as indicated at step 518. VRU 120b at step 521 determines whether such a retry count value has reached zero. If it is determined that the retry count value has reached zero, VRU 120b at step 524 abandons further delivery of the message, deletes message file 333 and associated data file 335, and logs this abandonment event. Otherwise, VRU 120b at step 527 places data file 335 back to the aforementioned message queue, with fields 467 and 470 updated to reflect the time of the last delivery attempt, and the appropriate re-delivery time, respectively.

Again, where SS7 out-of-band signaling is implemented, e.g., the answer supervision coming from an SS7 signaling link, separate from the outbound channel, CPA 218 does not need to be applied to the SS7 voice trunk. Instead, call progress information (busy, ring-no-answer, number unavailable, answer supervision, etc.) can advantageously be determined more effectively from the SS7 signaling protocol than the in-band counterpart through the outbound channel.

Referring back to step 515, if it is determined that the message delivery call is answered, VRU 120b at step 529 retrieves message file 333 identified by the message file ID in field 455 of data file 335. In a first embodiment of the invention, VRU 120b automatically plays the caller's message from message file 333 to the answering party. However, in this second embodiment where the caller's message may be private, which needs to be delivered to its intended recipient directly, VRU 120b at step 530 plays a first announcement on the first outbound channel and waits for any response therefrom. Assuming in this instance that the caller previously recorded the destination party's name which is registered in message file 333, the first announcement illustratively says, “Hello, I have an important and private recorded message for [destination party's name]. Please press one when this person is on the line. If [destination party's name] is not available, please press two,” where [XX] denotes insertion by VRU 120b of previously recorded XX.

This first announcement may be repeated for a predetermined number of times. If VRU 120b receives (a) no response within a predetermined time-out period due, perhaps, to an answering machine's picking up the call, or (b) a DTMF tone corresponding to depression of a “2” key from the destination station, sensed by the DTMF function of voice card 302, the subject routine proceeds to step 518 previously described. However, if a DTMF tone corresponding to depression of a “1” key is sensed, the subject routine proceeds to step 533 described below. Otherwise, if a DTMF tone corresponding to depression of any key other than the “1” or “2” key is sensed, the subject routine proceeds to step 524 previously described.

It should be noted at this point that in an alternative embodiment, whether an answering machine picks up a call is identified using a CPA 218. In that embodiment, CPA 218 is programed to distinguish between a recorded greeting from an answering machine and a live greeting from an actual person after the call is picked up. For example, CPA 218 may be programed to analyze the energy level of the greeting to realize the distinction. As is well known, the energy level of a live greeting (e.g., “Hello”) follows a short bursty pattern. On the other hand, the energy level of a recorded greeting (e.g., “I am not here right now. Please leave a message after the tone . . . ”) follows a prolonged, relatively even intensity pattern. Alternatively, CPA 218 may be programed to detect the delay of a greeting after the call is picked up to distinguish between a live greeting and a recorded greeting. As is also well known, a recorded greeting from an answering machine normally does not come on as immediately as a live greeting after a call is picked up.

At step 533, VRU 120b plays a second announcement on the first outbound channel. Assuming in this instance that the caller also recorded the caller's name which is registered in message file 333, the second announcement illustratively says, “This message is from [caller's name] recorded on [date] and [time].” VRU 120b at step 536 in FIG. 6B plays the caller's message from message file 333. After delivering the message, VRU 120b at step 539 plays a third announcement and then waits for any response. For example, this third announcement may say, “That concludes the message for [caller's name]. To replay this message, press one now, to call the sender back, press two now, to end this call, simply hang up.” If VRU 120b receives a DTMF tone corresponding to depression of a “1” key from the destination station, the subject routine returns to step 536. If VRU 120b receives a DTMF tone corresponding to depression of a “2” key, the subject routine proceeds to step 545 described below. Otherwise, VRU 120b at step 542 terminates the call after a predetermined time-out period expires, and deletes message file 333 and associated data file 335.

At step 543 where the destination party has chosen to call the caller back, VRU 120b deletes message file 333 and associated data file 335. VRU 120b at step 545 plays a fourth announcement on the first outbound channel, e.g., “Please stand by while we attempt to connect you to [caller's name].” VRU 120b at step 547 looks up the caller's telephone number in field 458 of data file 335, and transmits the number to switch host computer 106. At step 550 VRU 120b, which is connected to the destination station through the first outbound channel as a 2-party call, requests switch host computer 106 to transfer the call from itself to the caller's station, thereby relinquishing the VRU part in the connection. In response, computer 106 seizes a second one of outbound channels 102b from T1 interface 230, provides the caller's telephone number to switch 104 to outdial the caller's telephone number, and bridges the first outbound channel to the second outbound channel, thereby connecting the destination party to the caller's telephone number. The bridged connection allows the destination party to converse with the caller through the first and second outbound channels until either party disconnects. At such time, switch 104 tears down the connection and returns the first and second outbound channels to the reserve.

In another embodiment of the invention, a caller is allowed to leave a message not only for the destination number, but also other telephone number(s) desired by the caller. This is particularly advantageous where a called party has different contact numbers, e.g., a work number and home number. For example, when a caller tries to call the called party at his/her work number and encounters a ring-no-answer condition, the caller may immediately try the caller's home number, without bothering to leave a message at the work number. However, if the call to the home number also cannot be successfully completed, the caller may want to leave an identical message for both the called party's home number and work number. To that end, the routine of FIG. 4 is modified to also include step 701 in FIG. 7 which precedes step 403 in the routine. At step 701, VRU 120b elicits from the caller any telephone numbers other than the destination number to which the message is to be delivered. For the destination number (e.g., the home number), and each additional telephone number (e.g., the work number) provided by the caller via DTMF signaling or voice recognition, step 403 is repeated. In the event that for whatever reasons the caller does not want to leave a message for the destination number in favor of leaving a message for other telephone numbers just provided, the caller may enter in response to step 403 a predetermined cancellation code, e.g., all zeros, for the preferred time range corresponding to the destination number. At step 427, VRU 120b creates a data file modified from file 335, wherein for each additional telephone number provided by the caller, and the destination number for which the caller did not enter the predetermined cancellation code, data block 501 (including fields 461 through 494) in FIG. 5 is repeated in the modified data file. Each data block 501 is associated with the destination number, or one of the additional telephone numbers provided by the caller, and is led by field 461 containing the number. It should be noted that other fields in data block 501 may vary from one telephone number to another as well. That is, the preferences (e.g., delivery time ranges, delivery attempt frequencies, etc.) for delivering the same message to different telephone numbers may be independent. For example, the preferred time range for attempting a message delivery to the called party's work number may be from 8:00 a.m. to 5:00 p.m. On the other hand, the preferred time range for attempting a message delivery to the called party's home number may be from 8:00 p.m. to 10:00 p.m.

It should be noted that in delivering the same message to multiple telephone numbers, once the caller's message is played for one of the telephone numbers, because of step 542 and step 553 in FIG. 6B which delete message file 333 and associated data file 335 thereafter, the message will not be played for any other number and any further message delivery attempts will be halted.

It should also be noted that the voice message by the caller may be converted manually or by speech recognition to one or more versions thereof for different transmission media, e.g., a facsimile version, an email version, a short message service (SMS) version, etc., specified by the caller as preferences, along with other specified preferences in the routine of FIG. 4. The delivery of the converted version to an appropriate communication device is then attempted, whose address is elicited from the caller in a manner similar to step 701 in FIG. 7. Thus, for example, where the converted version is a facsimile version, a delivery of the converted version is attempted on to a facsimile device whose facsimile number is provided by the caller.

In another embodiment, system 100 maintains private directories or contacts folders for the caller. Each contacts folder contains the telephone numbers (e.g., home and office numbers), facsimile number(s), pager number(s), email address(es), etc. of a contact of the caller. The manner in which an operator accesses, for the caller, contact information from one such folder, including a desired destination number, is fully described in commonly assigned, copending application Ser. No. 09/865,230 filed on May 25, 2001, which is hereby incorporated by reference. Thus, where the called party's telephone number is initially retrieved from a contacts folder concerning the called party, VRU 120b may automatically retrieve other contact information such as the called party's facsimile number(s), pager number(s), email address(s), etc., thereby obviating the need of step 701 which would otherwise elicit such information from the caller.

The inventive message delivery service described above may further be utilized by a caller to realize a wakeup call function, an event reminder function, etc. To that end, the preferred time range field 473 in data file 335 is expanded to also accept a date input. Thus, the time format in field 473 may be hr/min/mm/dd/yy, where hr represents an hour value; min represents a minute value; mm represents a month value; dd represents a day value; and yy represents a year value. For example, to realize the wake-up call function, the caller may call system 100 and request an operator to connect him/her to the routine of FIG. 4 including the additional step 701. Alternatively, the caller may call a special access number, e.g., a 1-800-XXX-XXXX number, to access the routine directly. In any event, the caller is then provided with the option of leaving a message, which is a wake-up message in this instance, for his/her current telephone number or any other desired telephone numbers at which he/she may want to receive the wake-up message. In response to the time range elicitation in step 403, the caller enters the start time and end time of the preferred time range within which a wake-up call containing the wake-up message is initiated. If the wake-up call has to be initiated at a particular time, both the start time and end time are set to the particular time.

The wake-up message by the caller may include simply “It's time to wake up” or any other content desired by the caller, such as a reminder of notable events for the rest of the day. We have recognized that the wake-up call function is really a special case of a more general event reminder function afforded by the inventive service. This event reminder function allows the caller to remind himself/herself of an upcoming event, e.g., a meeting, a birthday, an anniversary, etc. ahead of the event time.

The realization of the event reminder function is similar to that of the wake-up call function described above. The caller may similarly call system 100 for an operator's assistance or the aforementioned special access number directly. The caller is then provided with the option of leaving a message, which is an event reminder in this instance, for the current telephone number or any other desired telephone numbers at which the caller may want to receive the event reminder. In response to the time range elicitation in step 403 for each telephone number, the caller enters the start time and end time of the preferred time range within which the event reminder is delivered.

The foregoing merely illustrates the principles of the invention. It will thus be appreciated that those skilled in the art will be able to devise numerous other arrangements which embody the principles of the invention and are thus within its spirit and scope.

For example, the announcements, including key selectable options, used in the above-described message delivery call are for illustrative purposes only. It will be appreciated that these announcements will vary depending on whether the caller's name and/or the destination party's name is recorded by the caller; whether the message is private, i.e., for the intended recipient only; etc.

In addition, an announcement of the caller's telephone number to which a callback is made may be desired by the destination party for future reference. Thus, in an alternative embodiment, the caller's telephone number is announced to the destination party if he/she so chooses. To that end, the third announcement in step 545 in FIG. 6B is modified to also ask the destination party to press a predetermined key, e.g., a “#” key, if he/she wants to hear the caller's telephone number. If a depression of the “#” key is detected within a time-out period, VRU 120b performs step 847 in FIG. 8, followed by performance of step 550, thereby bypassing step 547. As shown in FIG. 8, VRU 120b at step 847 looks up the caller's telephone number in field 458 of data file 335, announces the number to the destination party, and transmits the number to switch host computer 106.

Moreover, in the illustrative embodiments, after the caller decides to leave a message for the destination party, the caller is prompted to record the message. However, in an alternative embodiment, the caller is afforded a selection of prefabricated messages provided by VRU 120b. One such prefabricated message selectable by the caller for the destination party may simply be “Please call back.” Upon hearing this message in an automated voice, the destination party may proceed to select the call-back option.

Further, in the illustrative embodiments, the telephone number used for calling the caller back is, by default, the telephone number of the station from which the initial information assistance call by the caller originates. However, in an alternative embodiment, the caller is prompted to provide a desired telephone number for the destination party to call back, which may be different from the originating number. In that embodiment, the desired call-back number may be registered in field 458 of data file 335 in lieu of the originating number.

Finally, information assistance system 100 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. Apparatus for facilitating communications between a caller and a called party, the apparatus comprising:
a processor for determining an unsuccessful communication between the caller and the called party;
storage for storing a message desired by the caller in response to the unsuccessful communication, and a plurality of addresses, each address being associated with a respective one of communication devices to which a version of the message is to be delivered; and
a switching mechanism for causing an establishment of a connection to deliver a version of the message to one of the communication devices based on the address associated therewith.

2. The apparatus of claim 1 further comprising a signal processor for detecting a signal generated by the communication device to which the message is delivered, the switching mechanism in response to the detected signal initiating a call to the caller.

3. The apparatus of claim 2 wherein the signal includes a DTMF signal.

4. The apparatus of claim 1 wherein the message is recorded by the caller.

5. The apparatus of claim 1 wherein the plurality of addresses include at least one telephone number.

6. The apparatus of claim 1 wherein the communication devices includes at least one telephonic device.

7. The apparatus of claim 1 wherein the version of the message delivered is the same as the stored message.

8. The apparatus of claim 1 wherein the stored message includes a voice message, and the version of the message delivered includes a facsimile version of the voice message.

9. The apparatus of claim 1 wherein the stored message includes a voice message, and the version of the message delivered includes an email version of the voice message.

10. The apparatus of claim 1 wherein the message includes a reminder of an event.

11. The apparatus of claim 1 wherein the message includes a wake-up message.

12. A messaging system comprising:
storage for storing a message for a called party from a caller whose call to a called station associated with the called party was previously unanswered;
an interface for receiving from the caller one or more telephone numbers, other than a telephone number associated with the called station, the one or more telephone numbers being associated with a plurality of stations, respectively; and
a switch for causing an establishment of a connection to deliver the message to one of the called station and the plurality of stations based on the telephone number associated therewith.

13. The system of claim 12 wherein the interface obtains from the caller at least one preference concerning delivery of the message.

14. The system of claim 13 wherein the at least one preference is associated with one of the telephone numbers.

15. The system of claim 13 wherein the at least one preference includes a time range within which the message is delivered.

16. The system of claim 12 wherein the number of attempts to deliver the message is not greater than a predetermined maximum limit.

17. The system of claim 12 wherein the call was unanswered due to a busy condition.

18. The system of claim 12 wherein the call was unanswered due to a ring-no-answer condition.

19. The system of claim 12 wherein the call was unanswered due to a communication problem.

20. The system of claim 12 further comprising a device for detecting a predetermined signal from the station to which the message is delivered, the switch, in response to the predetermined signal, establishing a second connection to a calling station associated with the caller.

21. The system of claim 20 wherein a telephone number associated with the calling station is derived from an automatic number identification (ANI).

22. The system of claim 20 wherein the predetermined signal includes a DTMF signal.

23. The system of claim 12 wherein the message includes a reminder of an event.

24. The system of claim 12 wherein the message includes a wake-up message.

25. A communications system accessible by a user for obtaining information about a desired party, the system comprising:
a server for providing a destination telephone number for contacting the desired party;
a switch for establishing a first connection to a destination station associated with the destination telephone number;
a processor for monitoring signals on the first connection;
an interface for prompting the user to leave a message when a signal from the first connection indicating that the destination station is not answering is detected; and
storage for storing the message, the destination telephone number, and one or more other telephone numbers for contacting the desired party, the one or more other telephone numbers being respectively associated with other stations than the destination station, the switch establishing a second connection to one of the destination station and other stations to deliver the message based on the telephone number associated therewith.

26. The system of claim 25 wherein the detected signal includes a busy signal.

27. The system of claim 25 wherein the detected signal includes a signal indicative of a ring-no-answer condition.

28. The system of claim 25 wherein the detected signal includes a signal indicative of a communication problem.

29. The system of claim 25 further comprising an operator assisting the user to obtain the information.

30. The system of claim 25 further comprising a device for detecting a predetermined signal from the station to which the message is delivered, the switch, in response to the detected predetermined signal, establishing a third connection to a calling station associated with the user.

31. The system of claim 30 wherein a calling telephone number associated with the calling station is derived from an ANI.

32. The system of claim 31 wherein the calling telephone number is provided by the user.

33. The system of claim 30 wherein the predetermined signal includes a DTMF signal.

34. A method for facilitating communications between a caller and a called party, the method comprising:
determining an unsuccessful communication between the caller and the called party;
storing a message desired by the caller in response to the unsuccessful communication, and a plurality of addresses, each address being associated with a respective one of communication devices to which a version of the message is to be delivered; and
causing an establishment of a connection to deliver a version of the message to one of the communication devices based on the address associated therewith.

35. The method of claim 34 further comprising detecting a signal generated by the communication device to which the message is delivered, the switching mechanism in response to the detected signal initiating a call to the caller.

36. The method of claim 35 wherein the signal includes a DTMF signal.

37. The method of claim 34 wherein the message is recorded by the caller.

38. The method of claim 34 wherein the plurality of addresses include at least one telephone number.

39. The method of claim 34 wherein the version of the message delivered is the same as the stored message.

40. The method of claim 34 wherein the stored message includes a voice message, and the version of the message delivered includes a facsimile version of the voice message.

41. The method of claim 34 wherein the stored message includes a voice message, and the version of the message delivered includes an email version of the voice message.

42. The method of claim 34 wherein the message includes a reminder of an event.

43. The method of claim 34 wherein the message includes a wake-up message.

44. A method for use in a messaging system comprising:
storing a message for a called party from a caller whose call to a called station associated with the called party was previously unanswered;
receiving from the caller one or more telephone numbers, other than a telephone number associated with the called station, the one or more telephone numbers being associated with a plurality of stations, respectively; and
causing an establishment of a connection to deliver the message to one of the called station and the plurality of stations based on the telephone number associated therewith.

45. The method of claim 44 further comprising obtaining from the caller at least one preference concerning delivery of the message.

46. The method of claim 45 wherein the at least one preference is associated with one of the telephone numbers.

47. The method of claim 45 wherein the at least one preference includes a time range within which the message is delivered.

48. The method of claim 44 wherein the number of attempts to deliver the message is not greater than a predetermined maximum limit.

49. The method of claim 44 wherein the call was unanswered due to a busy condition.

50. The method of claim 44 wherein the call was unanswered due to a ring-no-answer condition.

51. The method of claim 44 wherein the call was unanswered due to a communication problem.

52. The method of claim 44 further comprising detecting a predetermined signal from the station to which the message is delivered; and
in response to the predetermined signal, establishing a second connection to a calling station associated with the caller.

53. The method of claim 52 wherein a telephone number associated with the calling station is derived from an ANI.

54. The method of claim 52 wherein the predetermined signal includes a DTMF signal.

55. The method of claim 44 wherein the message includes a reminder of an event.

56. The method of claim 44 wherein the message includes a wake-up message.

57. A method for use in a communications system accessible by a user for obtaining information about a desired party, the method comprising:
providing a destination telephone number for contacting the desired party;
establishing a first connection to a destination station associated with the destination telephone number;
monitoring signals on the first connection;
prompting the user to leave a message when a signal from the first connection indicating that the destination station is not answering is detected;
storing the message, the destination telephone number, and one or more other telephone numbers for contacting the desired party, the one or more other telephone numbers being respectively associated with other stations than the destination station; and
establishing a second connection to one of the destination station and other stations to deliver the message based on the telephone number associated therewith.

58. The method of claim 57 wherein the detected signal includes a busy signal.

59. The method of claim 57 wherein the detected signal includes a signal indicative of a ring-no-answer condition.

60. The method of claim 57 wherein the detected signal includes a signal indicative of a communication problem.

61. The method of claim 57 further comprising detecting a predetermined signal from the station to which the message is delivered; and
in response to the detected predetermined signal, establishing a third connection to a calling station associated with the user.

62. The method of claim 61 wherein a calling telephone number associated with the calling station is derived from an ANI.

63. The method of claim 62 wherein the calling telephone number is provided by the user.

64. The method of claim 61 wherein the predetermined signal includes a DTMF signal.
